(19) United States
(12) Patent Application Publication
(10) Pub. No.: US 2017/0060398 A1
(43) Pub. Date: Mar. 2, 2017

(54) DYNAMIC DISPLAY OF USER INTERFACE ELEMENTS IN HAND-HELD DEVICES

(71) Applicant: SAP SE, Walldorf (DE)

(72) Inventor: ASHUTOSH RASTOGI, BANGALORE (IN)

(21) Appl. No.: 14/843,829

(22) Filed: Sep. 2, 2015

(51) Int. Cl. G06F 3/0484; G06F 3/01; G06F 3/0482

(52) U.S. Cl. CPC G06F 3/04847; G06F 3/0482; G06F 3/017

(57) ABSTRACT

Signals from one or more sensors are received in a hand-held device. A position of the hand-held device is dynamically detected based on the signals received from the one or more sensors in the hand-held device. Upon determining that the position is right-handed, UI elements are dynamically displayed on first area of a GUI in the hand-held device. Shift in the position of the hand-held device is dynamically detected based on signals received from the one or more sensors in the hand-held device. Upon determining the shift in the position is left-handed, the UI elements are dynamically displayed on second area of the GUI in the hand-held device.

### FIELD

Embodiments of the invention generally relate to computer graphics processing and selective visual display systems, and more particularly to dynamic display of actionable items in devices.

### BACKGROUND

In electronic devices, when input devices such as mouse, track pad, etc., are used, an user is provided with a pointer on a graphical user interface (GUI) screen, using which the user can position and perform operations such as click, hover, select, etc. However, in hand-held devices, the interaction with the hand-held device is based on touch interaction by positioning fingertip on the GUI of the device. In applications rendered or displayed on the touch based devices, menu items are displayed statically on the content at fixed positions in the GUI. Users of such hand-held devices may access the applications by holding the touch devices in either of the hand. The hand-held touch devices may be of varying screen sizes, and also the touch devices may be held in landscape orientation instead of portrait orientation. In both the scenarios noted above, it is challenging to access the statically displayed actionable items across a wide screen of the hand-held device.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating position of UI elements in a hand-held device, according to an embodiment.

FIG. 2 is a block diagram illustrating dynamic display of UI elements in a hand-held device, according to an embodiment.

FIG. 3 is a block diagram illustrating operating system settings in a hand-held device, according to an embodiment.

FIG. 4 is a block diagram illustrating application settings in a hand-held device, according to one embodiment.

FIG. 5 is a block diagram illustrating hardware sensors in a hand-held device, according to one embodiment.

FIG. 6 is a block diagram illustrating hardware sensors in a hand-held device, according to one embodiment.

FIG. 7 is a block diagram illustrating hardware sensors in a hand-held device, according to one embodiment.

FIG. 8 is a flow diagram illustrating process of dynamic display of user interface elements in hand-held devices, according to one embodiment.

FIG. 9 is a block diagram illustrating an exemplary computer system, according to one embodiment.

### DETAILED DESCRIPTION

Embodiments of techniques for dynamic display of user interface elements in hand-held devices are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

A hand-held device may be a multi-touch electronic device that users can control through multi-touch gestures. Multi-touch gestures are predefined motions used to interact with multi-touch devices. Some examples of multi-touch gestures are hover, tap, double tap, long press, scroll, pan, pinch, rotate, etc. Users may use the multi-touch gestures to interact with the multi-touch electronic device, and the applications rendered in the multi-touch electronic device. Multi-touch gestures can be performed on various user interface (UI) elements such as a menu, popup screen, context menu, widget, icon, pointer, cursor, selection, handle, text cursor, insertion point, tabs, magnifier, window, etc. UI elements may also be referred to as actionable elements since actions such as selection, hover, clicking, etc., can be performed on the UI elements. The multi-touch electronic device may be held by the users in right hand, left hand, or both and this is referred to as handedness. Handedness is a preference or performance of use of a one hand over another. Handedness may be left-handedness, right-handedness, mixed-handedness and ambidexterity. Left-handedness is also referred to as dexterous, and right-handedness is also referred to as sinister.

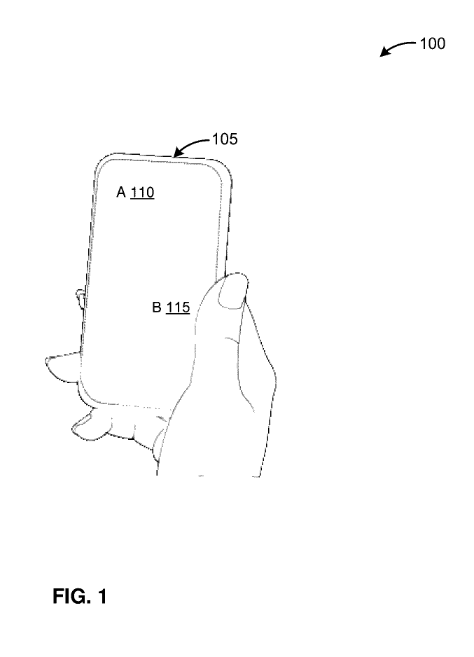

FIG. 1 is block diagram 100 illustrating position of UI elements in a hand-held device, according to one embodiment. Hand-held device 105 is shown displaying UI element ‘A’ 110 and UI element ‘B’ 115. The hand-held device 105 is held by a user in user's right hand. When the hand-held device 105 is held in right hand, and when the user accesses the UI elements using right hand thumb, location ‘B’ 115 is in close proximity with the right hand thumb and is easily accessible with the right hand thumb in comparison to location ‘A’ 110 that is not in close proximity to the right hand thumb.

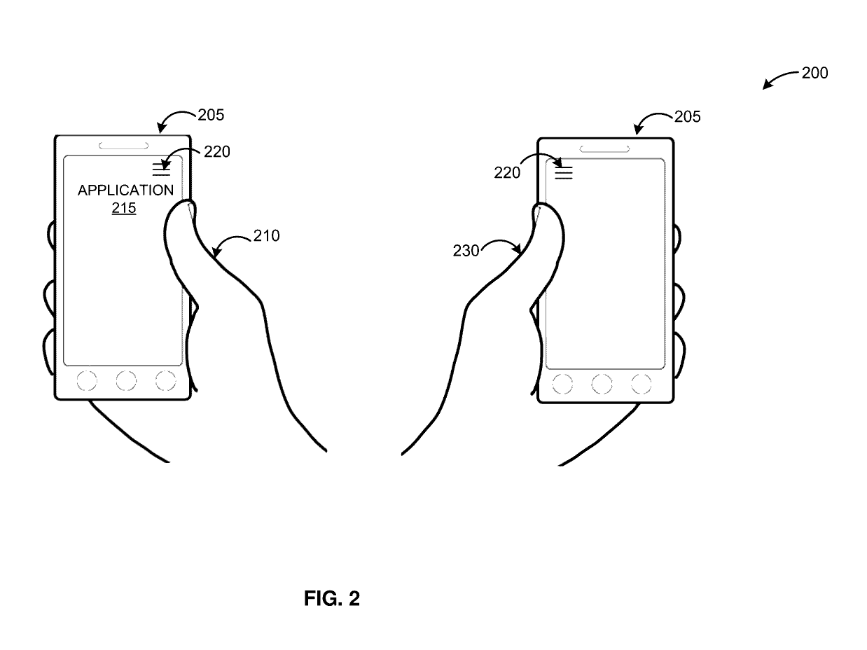

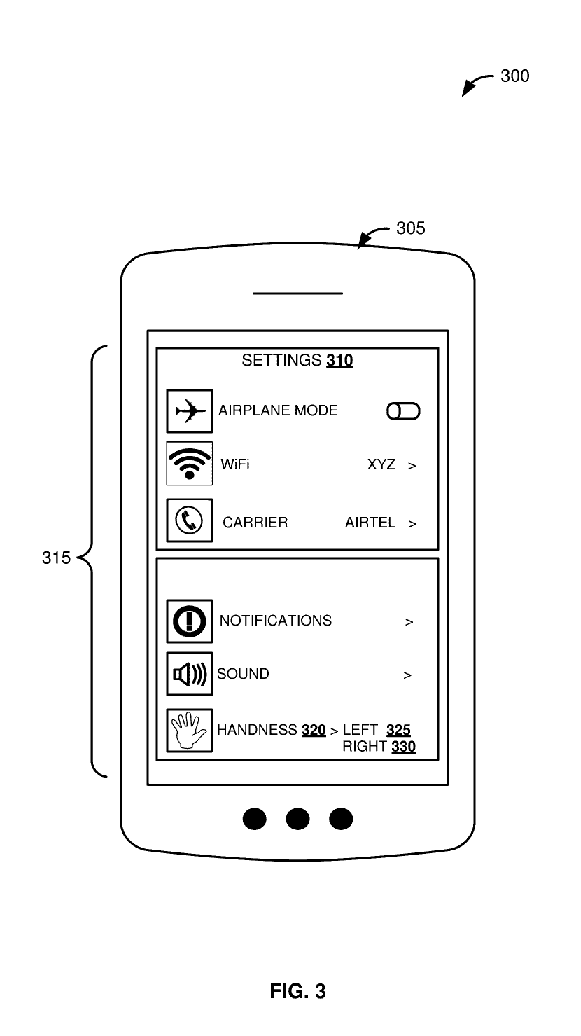

FIG. 2 is block diagram 200 illustrating dynamic display of UI elements in a hand-held device, according to one embodiment. Hand-held device 205 is held in right hand of a user as shown in 210. Application 215 is rendered in GUI of the hand-held device 205. Since the hand-held device 205 is held in the right hand of the user as shown in 210, UI elements 220 or actionable elements are dynamically rendered on a first area of the GUI. The first area of the GUI may be a right side or an area towards the right side of the GUI. Accordingly, the UI elements 220 are easily accessible from the right hand/right hand thumb. When the client device 205 is held in the left hand of the user as shown in 230, the UI elements 220 are dynamically rendered on a second area of the GUI. The second area of the GUI may be a left side or an area towards the left side of the GUI. Accordingly, the UI elements 220 are easily accessible from the left hand/left hand thumb. Depending on the handedness of the user, placement/position of the hand-held device 205 dynamically changes. As the position of the hand-held device 205 changes or shifts from the user's right hand to left hand, the display of UI elements 220 on the first area of the GUI as shown in 210 is dynamically shifted or dynamically moved to the second area of the GUI as shown in 220. Dynamic shifting or dynamically moving may be a shift in position or location or displacement occurring gradually or instantly. There are various ways in which dynamic display of the UI elements may be implemented. FIG. 3 to FIG. 5 illustrates various techniques of implementation of dynamic display of UI elements.

FIG. 3 is a block diagram 300 illustrating operating system settings in a hand-held device, according to one embodiment. Hand-held device 305 is shown displaying settings 310. Settings 310 represent operating system settings of the hand-held device 305. Settings 310 have various parameters 315 such as airplane mode, Wi-Fi, carrier, notifications, sound, handedness, etc. User can specify a preference in handedness 320 by selecting either left 325 or right 330. When the user selects left 325, UI elements in applications may be displayed on a second area or towards left side of the GUI of the hand-held device 305. The second area is in a close proximity and easily accessible from the left hand, for example, an area from left side top to left side bottom of the GUI of the hand-held device. When the user selects right 330, the UI elements in the applications may be displayed on a first area or towards right side of the GUI of the hand-held device 305. The first area is in a close proximity and easily accessible from the right hand, for example, an area from right side top to right side bottom of the GUI of the hand-held device. Based on the handedness specified in the settings 310, the UI elements are displayed accordingly in the applications in the hand-held device 305. In one embodiment, a hardware toggle in the form of a hardware switch or button may be located in a hand-held device. User may choose to set the hardware switch in a first position or ON position to set handedness of the hand-held device to right hand. When the hardware switch is set to ON position, UI elements in applications may be rendered or displayed on the first area to towards the right side of GUI in the hand-held device. User may choose to set the hardware switch in a second position or OFF position to set handedness of the hand-held device to left hand. When the hardware switch is set to OFF position, the UI elements in applications may be rendered or displayed on the second area towards the left side of GUI in the hand-held device. User may choose to toggle the hardware switch between ON and OFF position.

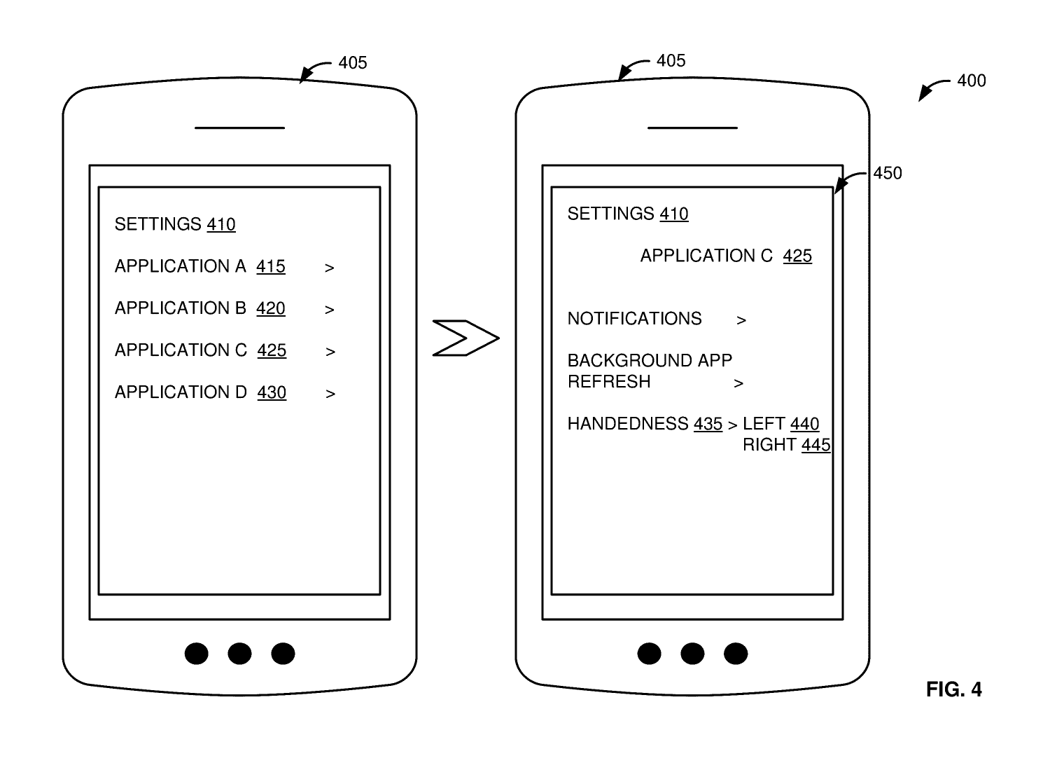

FIG. 4 is a block diagram 400 illustrating application settings in a hand-held device, according to one embodiment. Hand-held device 405 is shown displaying various applications such as ‘application A 415’, ‘application B 420, ‘application C 425’ and ‘application D 430’ installed in the hand-held device 405 in settings 410. User can specify handedness for individual applications ‘application A 415’, ‘application B 420, ‘application C 425’ and ‘application D 430’ installed in the hand-held device 405. ‘Application C’ 425 is selected and parameters corresponding to ‘application C’ 425 are displayed in GUI 450. In the parameter handedness 435, the user can specify either left 440 or right 445 as a preference of display of UI elements in ‘application C’ 425. When the user selects left 440, the UI elements in ‘application C’ 425 may be displayed on a second area or towards left side of the GUI of the hand-held device 405. When the user selects right 445, the UI elements in ‘application C’ 425 may be displayed on a first area or towards right side of the GUI of the hand-held device 405. Based on the handedness specified for an application, the UI elements are displayed accordingly. Similarly, for other applications, user can specify the handedness by selecting either left or right in the corresponding application settings in the hand-held device 405.

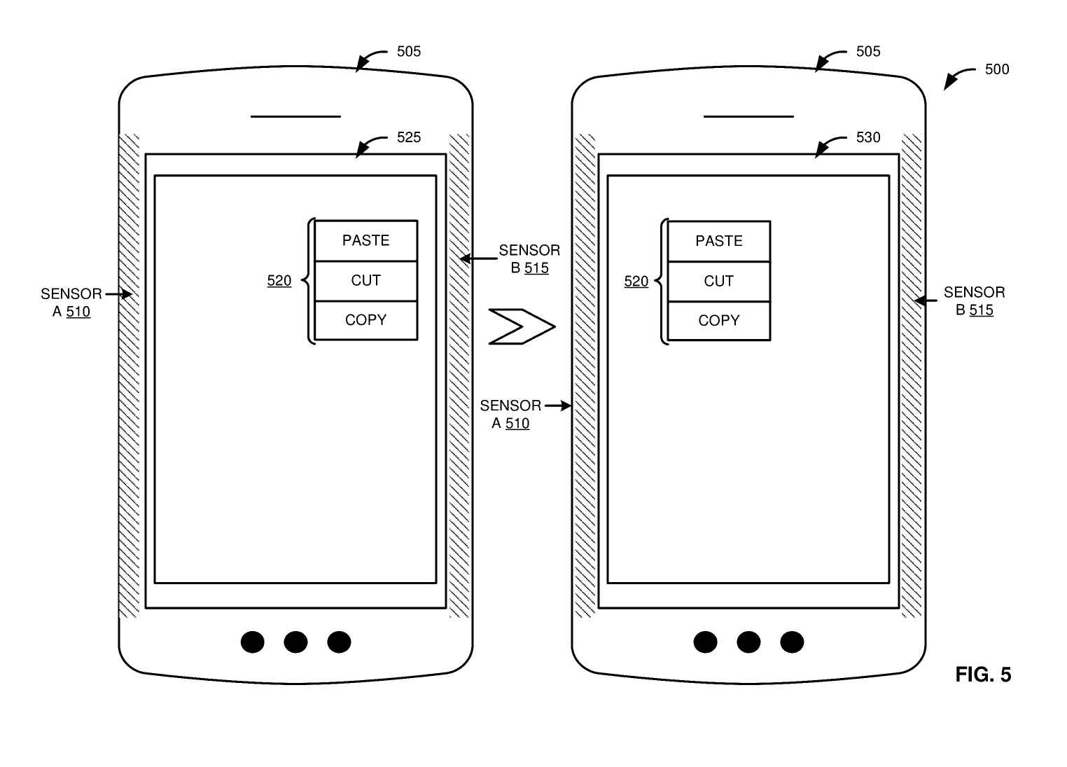

FIG. 5 is a block diagram 500 illustrating hardware sensors in a hand-held device, according to one embodiment. Hand-held device 505 is shown with sensors on both sides of the hand-held device. Sensors may be hardware sensors that detect the position in which the hand-held device is held, and convert into signal that can be used to dynamically adjust the display of UI elements. Dynamic display of UI elements may be performed by a combination of hardware sensors, and algorithms or software sensors that process the signal received form the hardware sensors. Algorithms or combination of algorithms such as edge gradient orientation of images, content based image retrieval, algorithm that combines capabilities of gyroscope and accelerometer functioning, etc., may be used. ‘Sensor A’ 510 and ‘sensor B’ 515 can be placed on both the sides of the hand-held device 505. When a user holds the hand-held device in right hand, ‘sensor B’ 515 detects a continuous touch on its surface and ‘sensor A’ 510 detects a non-continuous touch/signal on its surface. Because of the continuous touch/signal determined in surface of ‘sensor B’ 515, it is determined that there is a high probability that the client device 505 is held in the right hand and is in close proximity with the right hand, and dynamically displays UI elements ‘paste’, ‘cut’ and ‘copy’ 520 on a first area or towards right side of GUI 525 of the hand-held device 505. When the user switches the hand-held device 505 to the left hand, ‘sensor A’ 510 detects a continuous touch/signal on its surface and ‘sensor B’ 515 detects a non-continuous touch/signal on its surface. Because of the continuous touch/signal determined on the surface of ‘sensor A’ 510 it is determined that there is a high probability that the client device 505 is held in the left hand and is in close proximity with the left hand, and dynamically displays the UI elements ‘paste’, ‘cut’ and ‘copy’ 520 on a second area or towards left side of GUI 530 of the hand-held device 505.

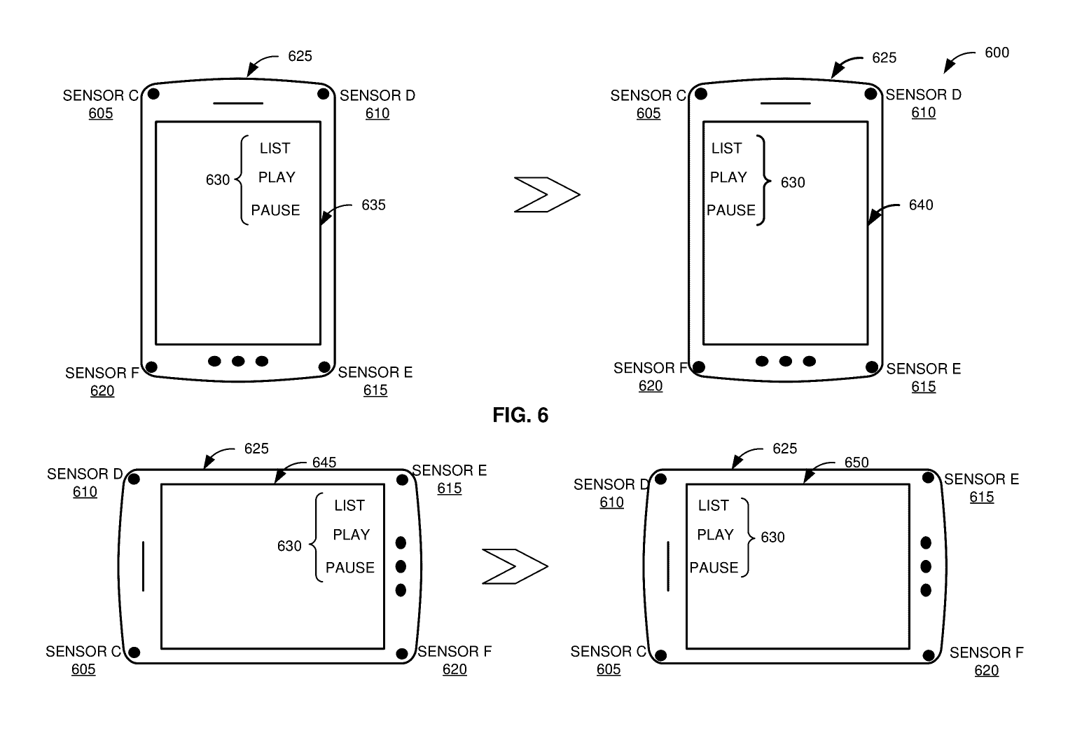

FIG. 6 is a block diagram 600 illustrating hardware sensors in a hand-held device, according to one embodiment. In one embodiment, hardware sensors may be placed on corners of the hand-held device. ‘Sensor C’ 605, ‘sensor D’ 610, ‘sensor E’ 615 and ‘sensor F’ 620 are placed on four corners of the hand-held device 625. When the hand-held device 625 is held in the right hand, ‘sensor D’ 610 and ‘sensor E’ 615 are in close proximity with right hand of a user. ‘Sensor D’ 610 and ‘sensor E’ 615 individually or in combination detect that the hand-held device 625 is held in the right hand of the user, and dynamically displays UI elements ‘list’, ‘play’ and ‘pause’ 630 on a first area or towards right side of GUI 635 of the hand-held device 625. When the user switches the hand-held device 625 to the left hand, ‘sensor C’ 605 and ‘sensor F’ 620 are in close proximity with the left hand of the user. ‘Sensor C’ 605 and ‘sensor F’ 620 detect that the hand-held device 625 is held in the left hand, and dynamically displays the UI elements ‘list’, ‘play’ and ‘pause’ 630 on a second area or towards left side of GUI 640 of the hand-held device 625. The placement of the hardware sensors is merely exemplary, various types of sensors in various locations of the client device can be used.

In one embodiment, orientation of the hand-held device 625 may be landscape instead of portrait. For example, touch based gaming remote devices may be held in landscape orientation instead of portrait orientation. The hand-held device 625 is held in landscape orientation by a user. When the hand-held device 625 is held in right hand of a user, ‘sensor E’ 615 and ‘sensor F’ 620 are in close proximity with the right hand. ‘Sensor E’ 615 and ‘sensor F’ 620 individually or in combination detect that the hand-held device 625 is held in the right hand, and dynamically displays the UI elements ‘list’, ‘play’ and ‘pause’ 630 on a first area or towards right side of GUI 645 of the hand-held device 625. When the user switches the hand-held device 625 to the left hand, ‘sensor D’ 610 and ‘sensor C’ 605 are in close proximity with the left hand. ‘Sensor D’ 610 and ‘sensor C’ 605 individually or in combination detect that the hand-held device 625 is held in the left hand, and dynamically displays the UI elements ‘list’, ‘play’ and ‘pause’ 630 on a second area or towards left side of GUI 650 of the hand-held device 625.

In one embodiment, hand-held device 625 may be held in both the hands of a user in a landscape orientation. ‘Sensor E’ 615 and ‘sensor F’ 620 individually or in combination based on factors such as proximity to a hand and pressure received on the sensors, determine handedness of the hand-held device 625. Numeric values may be associated with the factors such as proximity to the hand and pressure received on the sensors. Computation of numerical values may be based on a program logic or algorithm associated with the sensors. For example, based on the proximity of right hand to ‘sensor E’ 615 and ‘sensor F’ 620, a numerical value of ‘0.25’ is calculated. Based on the pressure received from the right hand on ‘sensor E’ 615 and ‘sensor F’ 620, a numerical value is calculated as ‘0.27’. With reference to the right hand, sum of the calculated numerical values ‘0.25 and ‘0.27’ is ‘0.52’.

Based on the proximity of left hand to ‘sensor D’ 610 and ‘sensor C’ 605, a numerical value of ‘0.22’ is calculated. Based on the pressure received from the left hand on ‘sensor D’ 610 and ‘sensor C’ 605, a numerical value is calculated as ‘0.20’. With reference to the left hand, sum of the calculated numerical values ‘0.22 and ‘0.20’ is ‘0.42’. A threshold value of ‘0.05’ can be used in determining the handedness. The delta/difference of the calculated numerical values with reference to the left hand and right hand is compared with the threshold value of ‘0.05’. The delta/difference between the calculated numerical value of right hand with reference to the left hand is ‘0.1’ and is greater than the threshold value ‘0.05’, and accordingly it is determined that the handedness is right. The UI elements ‘list’, ‘play’ and ‘pause’ 630 are displayed in a first area or towards right side of GUI 645 of the hand-held device 625. Alternatively, if the delta/difference between the calculated numerical value of the left hand with reference to the right hand is ‘0.1’ and is greater than the threshold value ‘0.05’, it is determined that the handedness is left.

In one embodiment, if delta/difference of the calculated numerical values with reference to the left hand and right hand are below the threshold value ‘0.05, conflict in handedness may be resolved in using various options explained below. When the delta/difference between the calculated numerical values with reference to the left hand and right hand is below the threshold value ‘0.05, handedness can be determined by prompting a user to select between right and left handedness to resolve the conflict. User activity or preference of handedness can be maintained in a history/user preference in the program logic or algorithm associated with the sensors. When the delta/difference between the calculated numerical values with reference to the left hand and right hand is below the threshold value ‘0.05’, the stored history/user preference is used to determine the handedness and resolve the conflict.

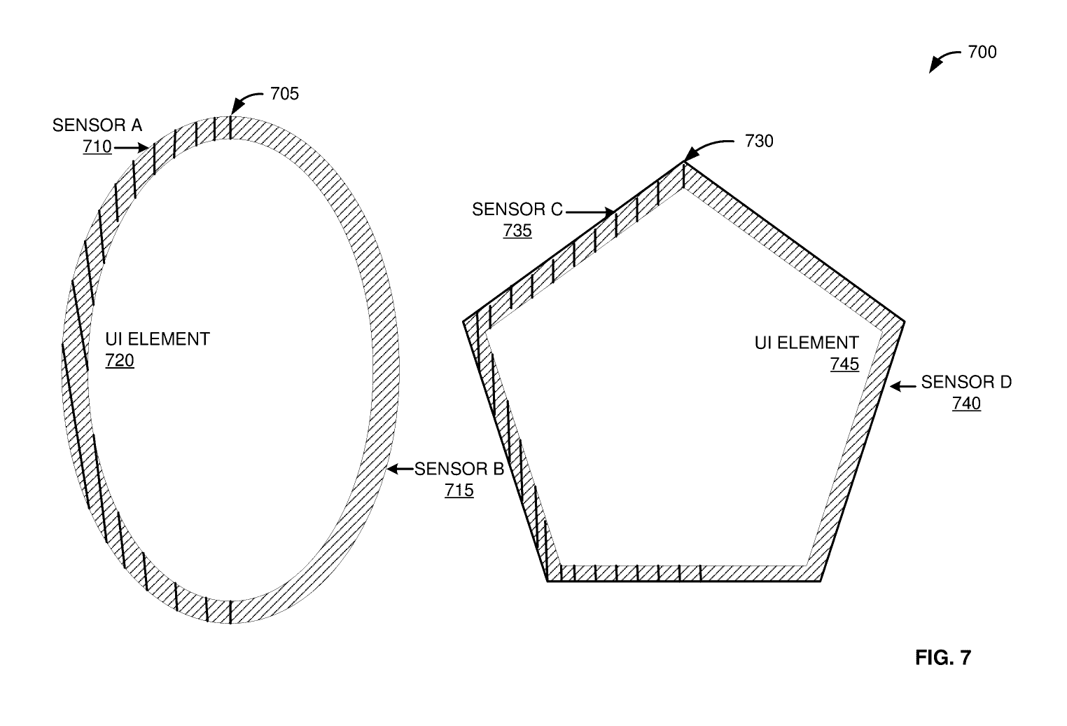

FIG. 7 is a block diagram 700 illustrating hardware sensors in a hand-held device, according to one embodiment. In one embodiment, hardware sensors may be placed on circumference or periphery of the hand-held device. Consider hand-held device 705 that is oval in shape. ‘Sensor A’ 710 and ‘sensor B’ 715 is placed on the circumference of the hand-held device 705. When the hand-held device 705 is held in the left hand, ‘sensor A’ 710 dynamically determines that pressure is received on the ‘sensor A’ 710 and determines that the hand-held device 705 is held in left hand. Accordingly, UI elements 720 are displayed on a second area or towards left side of GUI of the hand-held device 705. When the hand-held device 705 is shifted to right hand, ‘sensor B’ 715 dynamically determines that pressure is received on the ‘sensor B’ 715 and determines that the hand-held device 705 is held in the right hand. Accordingly, UI elements 720 are displayed on a first area or towards right side of GUI of the hand-held device 705 (not shown).

In one embodiment, hardware sensors may be placed on circumference or periphery of hand-held device 730. Consider a polygon shaped hand-held device 730, such as a touch based gaming remote. ‘Sensor C’ 735 and ‘sensor D 740’ are placed on the periphery of the hand-held device 730. When the hand-held device 730 is held in the right hand, ‘sensor D’ 740 dynamically determines that pressure is received on the ‘sensor D’ 740 and determines that the hand-held device 730 is held in the right hand. Accordingly, UI elements 745 are displayed on a first area or towards right side of GUI of the hand-held device 730. When the hand-held device 730 is shifted to the left hand, ‘sensor C’ 735 dynamically determines that pressure is received on the ‘sensor C’ 735 and determines that the hand-held device 730 is held in left hand. Accordingly, UI elements 745 are displayed on a second area or towards left side of GUI of the hand-held device 730 (not shown).

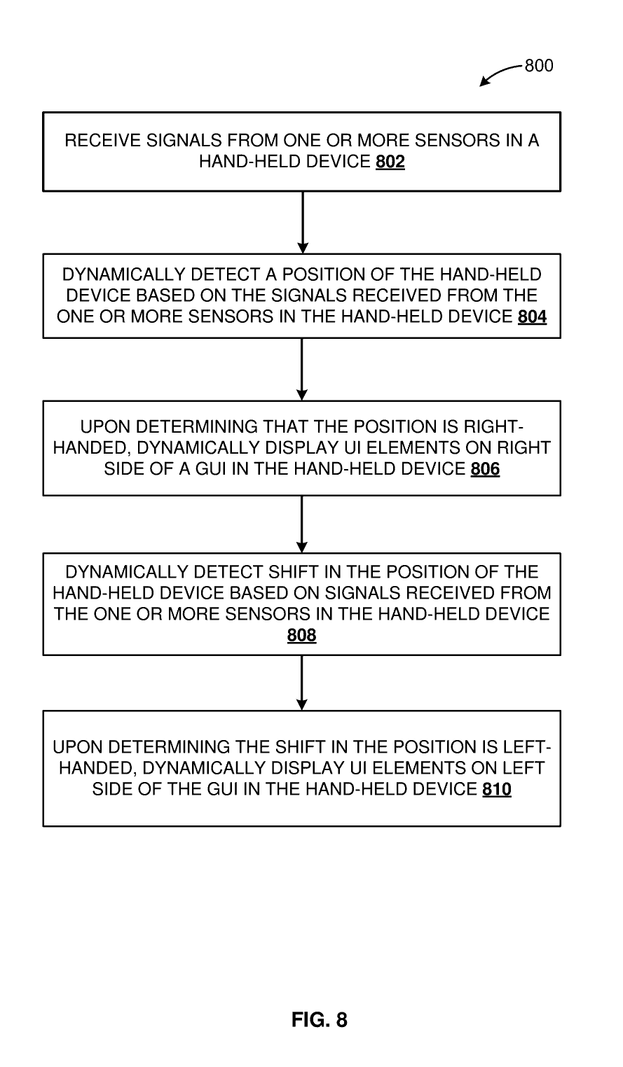

FIG. 8 is a flow diagram illustrating process 800 of dynamic display of user interface elements in hand-held devices, according to one embodiment. At 802, signals from one or more sensors are received in a hand-held device. At 804, a position of the hand-held device is dynamically detected based on the signals received from the one or more sensors in the hand-held device. Upon determining that the position is right-handed, at 806, UI elements are dynamically displayed on a first area of a GUI in the hand-held device. At 808, shift in the position of the hand-held device is dynamically detected based on signals received from the one or more sensors in the hand-held device. Upon determining the shift in the position is left-handed, at 810, UI elements are dynamically displayed on a second area of the GUI in the hand-held device. Dynamic display of UI elements in hand-held device enables a user to easily access the UI elements in the hand-held device in both landscape orientation and portrait orientation, and in hand-held devices of varying screen size and shapes.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

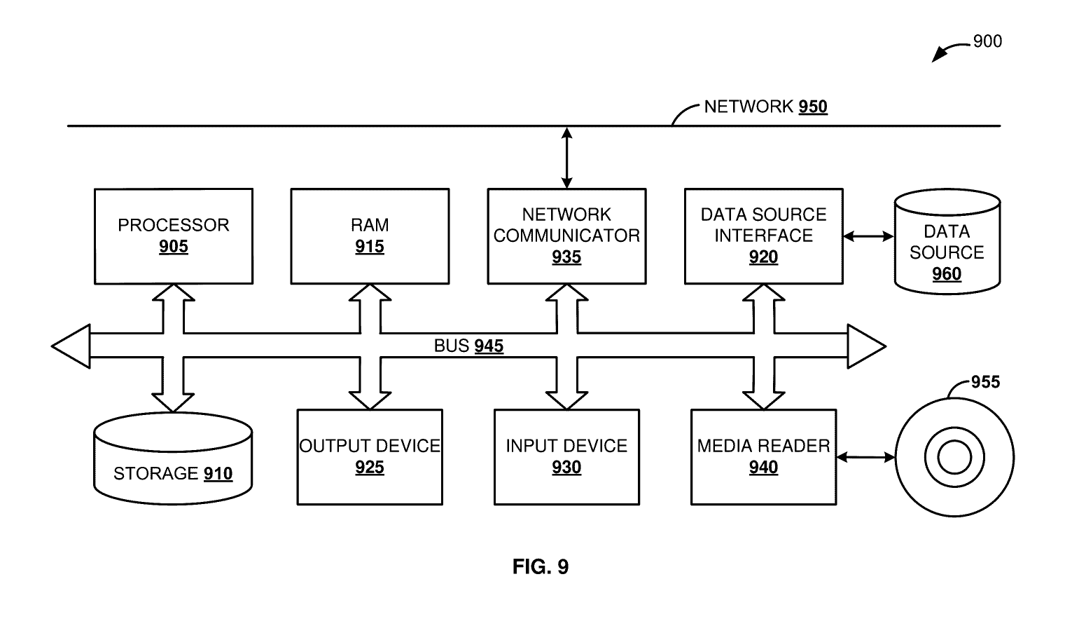

FIG. 9 is a block diagram illustrating an exemplary computer system 900, according to an embodiment. The computer system 900 includes a processor 905 that executes software instructions or code stored on a computer readable storage medium 955 to perform the above-illustrated methods. The processor 905 can include a plurality of cores. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. According to some embodiments, such as some in-memory computing system embodiments, the RAM 915 can have sufficient storage capacity to store much of the data required for processing in the RAM 915 instead of in the storage 910. In some embodiments, all of the data required for processing may be stored in the RAM 915. The stored instructions may be further compiled to generate other representations of the instructions and dynamically stored in the RAM 915. The processor 905 reads instructions from the RAM 915 and performs actions as instructed. According to one embodiment, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments and examples are described herein for illustrative purposes, various equivalent modifications are possible within the scope, as those skilled in the relevant art will recognize. These modifications can be made in light of the above detailed description.

What is claimed is:

1. A non-transitory computer-readable medium to store instructions, which when executed by a computer, cause the computer to perform operations comprising:
dynamically detect a position of a hand-held device based on signals received from one or more sensors in the hand-held device;
upon determining that the position is right-handed, dynamically display UI elements on a first area of a GUI in the hand-held device;
dynamically detect shift in the position of the hand-held device based on signals received from the one or more sensors in the hand-held device; and
upon determining the shift in the position is left-handed, dynamically display UI elements on a second area of the GUI in the hand-held device.

2. The computer-readable medium of claim 1, wherein, the display of UI elements on the first area of the GUI is in close proximity with right hand and continuous signal is received on the one or more sensors when the position is right-handed.

3. The computer-readable medium of claim 1, wherein, the display of UI elements on the second area of the GUI is in close proximity with the left hand and continuous signal is received on the one or more sensors when the position is left-handed.

4. The computer-readable medium of claim 1, to store instructions, which when executed by the computer, cause the computer to perform operations:
receive an input in a hardware toggle to switch the display of UI elements from left to right or right to left.

5. The computer-readable medium of claim 1, to store instructions, which when executed by the computer, cause the computer to perform operations:
receive the position as input in an operating system setting; and
based on the input, dynamically display the UI elements on the second area or first area of the GUI in the hand-held device.

6. The computer-readable medium of claim 1, to store instructions, which when executed by the computer, cause the computer to perform operations:
receive the position as input in an application setting; and
based on the input, dynamically display the UI elements on the second area or first area of the GUI in the hand-held device.

7. The computer-readable medium of claim 1, to store instructions, which when executed by the computer, cause the computer to perform operations:
based on signals received from the one or more sensors, calculate a first numerical value with reference to right hand and a second numerical value with reference to left hand associated with factors;
upon determining that the difference between the first numerical value and the second numerical value is greater than a threshold value, determine that the position is right-handed;
upon determining that the position is right-handed, dynamically display the UI elements on the first area of the GUI in the hand-held device;
upon determining that the difference between the second numerical value and the first numerical value is greater than the threshold value, determine that the position is left-handed; and
upon determining that the position is left-handed, dynamically display UI elements on the second area of the GUI in the hand-held device.

8. A computer-implemented method of dynamic display of user interface elements in hand-held devices, the method comprising:
dynamically detecting a position of a hand-held device based on signals received from one or more sensors in the hand-held device;
upon determining that the position is right-handed, dynamically displaying UI elements on first area of a GUI in the hand-held device;
dynamically detecting shift in the position of the hand-held device based on signals received from the one or more sensors in the hand-held device; and
upon determining the shift in the position is left-handed, dynamically displaying UI elements on second area of the GUI in the hand-held device.

9. The method of claim 8, wherein, wherein the display of UI elements on the first area of the GUI is in close proximity with right hand and continuous signal is received on the one or more sensors when the position is right-handed.

10. The method of claim 8, wherein, wherein the display of UI elements on the second area of the GUI is in close proximity with the left hand and continuous signal is received on the one or more sensors when the position is left-handed.

11. The method of claim 8, further comprising instructions which when executed by the computer further causes the computer to:
receiving an input in a hardware toggle to switch the display of UI elements from left to right or right to left.

12. The method of claim 8, further comprising instructions which when executed by the computer further causes the computer to:
receiving the position as input in an operating system setting; and
based on the input, dynamically displaying the UI elements on the second area or first area of the GUI in the hand-held device.

13. The method of claim 8, further comprising instructions which when executed by the computer further causes the computer to:
receiving the position as input in an application setting; and
based on the input, dynamically displaying the UI elements on the second area or first area of the GUI in the hand-held device.

14. The method of claim 8, wherein the one or more sensors are located on periphery of the hand-held device.

15. A computer system for dynamic display of user interface elements in hand-held devices, comprising:
a computer memory to store program code; and
a processor to execute the program code to:
dynamically detect a position of a hand-held device based on signals received from one or more sensors in the hand-held device;
upon determining that the position is right-handed, dynamically display UI elements on first area of a GUI in the hand-held device;
dynamically detect shift in the position of the hand-held device based on signals received from the one or more sensors in the hand-held device; and
upon determining the shift in the position is left-handed, dynamically display UI elements on second area of the GUI in the hand-held device.

16. The system of claim 15, wherein, the display of UI elements on the first area of the GUI is in close proximity with right hand and continuous signal is received on the one or more sensors when the position is right-handed.

17. The system of claim 15, wherein, the display of UI elements on the second area of the GUI is in close proximity with the left hand and continuous signal is received on the one or more sensors when the position is left-handed.

18. The system of claim 15, further comprising instructions which when executed by the computer further causes the computer to:
receive an input in a hardware toggle to switch the display of UI elements from left to right or right to left.

19. The system of claim 15, further comprising instructions which when executed by the computer further causes the computer to:
receive the position as input in an operating system setting; and
based on the input, dynamically display the UI elements on the second area or first area of the GUI in the hand-held device.

20. The system of claim 15, further comprising instructions which when executed by the computer further causes the computer to:
receive the position as input in an application setting; and
based on the input, dynamically display the UI elements on the second area or first area of the GUI in the hand-held device.
